(19) United States
(12) Patent Application Publication
(10) Pub. No.: US 2007/0282587 A1
(43) Pub. Date: Dec. 6, 2007

(54) Simulator System

(76) Inventors: Tetsuya Sato, Kanagawa (JP); Kunihiko Watanabe, Kanagawa (JP); Hiroshi Hirano, Kanagawa (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 11/660,492

(22) PCT Filed: Jan. 19, 2006
(86) PCT No.: PCT/JP06/00705

§ 371 Date: Feb. 16, 2007

(30) Foreign Application Priority Data
Jan. 24, 2005 (JP) 2005-015868

(51) Int. Cl. G06F 19/00

(52) U.S. Cl. 703/17

(57) ABSTRACT

Provided is a simulator system by which simulations as to a temporally and/or spatially changing event are executed at both macro layer and micro layer. The simulator system comprises an upper layer processor and a lower layer processor for executing simulation processes as to an upper layer and a lower layer, which are different from each other in scale, respectively, a multiplier connecting these layer processors, an integrated processing system including an allocator, which divides a simulation program to allocate to the respective layer processors, and a data storing unit, wherein the multiplier has an upper layer control unit connected to the upper layer processor and a lower layer control unit connected to the lower layer processor, and the upper layer control unit and the lower layer control unit are so constructed that informations are exchangeable with each other. The result of the simulation in each layer is utilized as information for a simulation in another layer.

### TECHNICAL FIELD

The present invention relates to a simulator system for simulating an event changing temporally and/or spatially. Particularly, the present invention relates to a simulator system for a hierarchically interlocked simulation that the whole of an object system of simulation composed of two hierarchies or layers different in scale as to, for example, both or one of a temporal scale and a spatial scale by, for example, at least 100,000 times is simulated.

### BACKGROUND ART

A simulation is conducted for the purpose of seeking the cause or expecting a situation appearing in the future, of a temporally changing event, a spatially changing event, or a temporally and spatially changing event or phenomenon such as, for example, a natural phenomenon such as aurora, or an artificially developed phenomenon, or for any other purpose.

A simulator system for executing a simulation has heretofore been fundamentally constructed by a computer system conducting a simulation process as to only a single layer.

### DISCLOSURE OF THE INVENTION

However, the simulator system composed of the single computer system fails to sufficiently execute simulation processes over a widely separated layers, specifically, layers the actual spatial scale of which is, for example, at least 100,000 times because there is a limit to the capacity or power of a hardware of the computer system making up this simulator system. For example, when a specific or singular phenomenon has occurred in a simulation process on a macroscopic scale, a simulation process on a microscopic scale as to the specific phenomenon itself or an influence thereof cannot be executed at the same time. Therefore, there is a problem that it takes a vast time and labor to obtain a sufficient simulated result as to a certain event.

On the other hand, in order to execute simulation processes as to a wide by separated layers, the scales of which are different by at least 100,000 times, by a single computer system, an extremely large-scaled computer system is required. It is however extremely difficult in fact to construct such an advanced computer system because of constraint called “quantum limit” and other limits, and forbiddingly expensive cost is required, so that such a process is unreal.

The present invention has been made on the basis of the foregoing circumstances and has as its object the provision of a simulator system for simulating a temporally and/or spatially changing event, by which simulation processes are executed as to an upper layer and a lower layer, which are different from each other in scale, a simulated result of each layer is utilized as information for simulation on the other layer, and consequently simulations as to the event can be performed in parallel on both of a macroscopic scale and a microscopic scale to execute simulations over a wide by separated layers.

The simulator system according to the present invention is a simulator system for simulating a temporally and/or spatially changing event, which comprises:

an upper layer processor and a lower layer processor for executing simulation processes as to an upper layer and a lower layer, which are different from each other in scale, respectively;

a multiplier connecting the upper layer processor and the lower layer processor;

an integrated processing system including an allocator, which statically divides a simulation program into a program for the upper layer and a program for the lower layer on the basis of a law system controlling the event about the object event of simulation and allocates them to the upper layer processor and the lower layer processor, respectively, and controlling the whole of the simulation; and

a data storing unit storing data obtained by the simulation,

wherein the upper layer processor and lower layer processor are each constructed by a computer system, and

wherein the multiplier has an upper layer control unit connected to the upper layer processor and a lower layer control unit connected to the lower layer processor, and the upper layer control unit and the lower layer control unit are so constructed that respective informations are exchangeable with each other.

Alternatively, the simulator system according to the present invention is a simulator system for simulating a temporally and/or spatially changing event, which comprises:

layer processors for executing simulation processes as to at least three layers, which are different from one another in scale, respectively;

a multiplier connecting an upper layer processor and a lower layer processor related to two layers adjoining each other in said at least three layers to each other;

an integrated processing system including an allocator, which statically divides a simulation program into a program for the upper layer and a program for the lower layer on the basis of a law system controlling the event about the object event of simulation and allocates them to the upper layer processor and the lower layer processor, respectively, and controlling the whole of the simulation; and

a data storing unit storing data obtained by the simulation,

wherein the layer processors are each constructed by a computer system, and

wherein the multiplier has an upper layer control unit connected to the upper layer processor and a lower layer control unit connected to the lower layer processor, and the upper layer control unit and the lower layer control unit are so constructed that respective informations are exchangeable with each other.

In the above-described simulator systems, the upper layer control unit and the lower layer control unit may be so constructed that informations are exchangeable with each other through a communicating system selected from an interlayer common memory, a remote direct memory access unit, a bus and a high-speed LAN.

In the above-described simulator systems, simulation processes by different simulation models may be executed at the same time in the upper layer processor and lower layer processor, respectively.

Further, the simulator systems may be so constructed that

when the degree of a change in a selected kind of information has exceeded a preset level in the upper layer processor, the information in the upper layer including said change is transferred from the upper layer processor to the lower layer control unit,

the execution of the simulation process by the upper layer processor is continued, and in parallel

therewith, a command to start execution of a simulation process according to a simulation model corresponding to the above change is issued from the lower layer control unit to the lower layer processor to execute the simulation process of the lower layer on the basis of the information transferred to the lower layer control unit in the lower layer processor.

Further, the simulator systems may be so constructed that

when the degree of a change in a selected kind of information has exceeded a preset level in the lower layer processor, the information in the lower layer including said change is transferred from the lower layer processor to the upper layer control unit,

the execution of the simulation process by the lower layer processor is continued, and in parallel therewith, a command to start execution of a simulation process according to a simulation model corresponding to the above change is issued from the upper layer control unit to the upper layer processor to execute the simulation process of the upper layer on the basis of the information transferred to the upper layer control unit in the upper layer processor.

Further, in the above-described, simulator systems, it may be preferable that the transfer of the midway information in the course of the execution of the simulation process in the upper layer processor or lower layer processor be executed only when the degree of a change in a selected kind of information has exceeded the preset level in the upper layer processor or lower layer processor.

Further, the information transferred to the upper layer processor and the information transferred to the lower layer processor may preferably be that subjected to an information content-reducing process corresponding to a simulation program executed in the upper layer processor or lower layer processor.

Further, in the above-described simulator systems, the scale of the layer of the simulation process executed in the upper layer processor may be at least 100,000 times as much as the scale of the layer of the simulation process executed in the lower layer processor.

According to the simulator systems of the present invention, the hierarchically interlocked simulator is constructed by the upper layer processor, the lower layer processor and the multiplier, and this simulator is operated by the integrated processing system, whereby a temporally and/or spatially changing event is regarded as an object event of simulation, the whole of that system is divided into plural layers of two or three layers or more, which are different in scale by at least 100, 000 times, to execute a simulation process every layer, so that sufficient simulations can be performed as to the whole system of the object event of simulation.

In addition, according to the simulator systems of the present invention, the processors are arranged variously and architecturally and integrated, whereby a simulator system capable of meeting various purposes can be provided.

In the simulator systems according to the present invention, simulation processes by different simulation models can be executed at the same time in the upper layer processor and lower layer processor, respectively, whereby the intended simulation can be executed with temporally high efficiency.

In addition, the simulation program is divided into a program for the upper layer and a program for the lower layer on the basis of a law system controlling the event about the temporally and/or spatially changing event, and they are allocated to the upper layer processor and the lower layer processor, respectively, to execute simulation processes, whereby simulation processes on the basis of different law systems can be executed in parallel, so that the intended simulation can be executed with temporally high efficiency.

Further, when change of information exceeding the preset level occurs in any layer processor, the information in that layer including said change is provided to the other layer processor to execute a simulation process on the basis of this information, so that the synthetical simulation result corresponding to the complex changes of the event can be obtained.

The transfer of the midway information in the course of the execution of the simulation process in any layer processor is executed only when the degree of a change in a selected kind of information has exceeded the preset level in said layer processor, whereby transfer of necessary information is ensured, and transfer of unnecessary information is omitted, so that the amount of the information transferred can be lessened as a whole, and the respective layer processors and layer control units, and the like may be those small in capacity from this point.

Further, the information transferred from one layer processor to the other layer processor is that subjected to an information content-reducing process corresponding to a simulation program executed in the other layer processor, whereby the amount of the information transferred can be lessened likewise, so that the respective layer processors and layer control units, and the like may be those small in capacity from this point.

The simulator systems according to the present invention are particularly useful even when the scale of the upper layer in two layers is at least 100,000 times as much as the scale of the lower layer, since a system for executing the intended simulation as to the object event of simulation can be constructed at low cost.

### BRIEF DESCRIPTION OF THE DRAWINGS

FIG. 1 is a block diagram illustrating the whole construction of a simulator system according to one embodiment of the present invention in a case where an object event of simulation is simulation-processed as to two layers of a macro layer and a micro layer.

FIG. 2 is a block diagram illustrating the flow of the whole process of simulation in the simulator system shown in FIG. 1.

FIG. 3 illustrates a magnetohydrodynamic simulation at a macro layer in a case where an object event of simulation is aurora.

FIG. 4 illustrates a particle simulation at a micro layer in the case where the object event of simulation is aurora, in which the action of electrons in this event is illustrated in a right-handed view, and an energy distribution of the electrons is illustrated in a left-handed diagram.

FIG. 5 illustrates a mode of information exchange between a micro simulation and a macro simulation on a time base.

### DESCRIPTION OF CHARACTERS

101 Integrated processing system
102 Upper layer processor
103 Multiplier
104 Lower layer processor
105 Data storing unit
111 Configuration control mechanism
112 Compiler
113 Allocator
114 Scheduler
115 Diagnostic information mechanism
131 Upper layer control unit
132 Interlayer common memory
133 Lower layer control unit

### BEST MODE FOR CARRYING OUT THE INVENTION

The simulator system according to the present invention will hereinafter be described in detail.

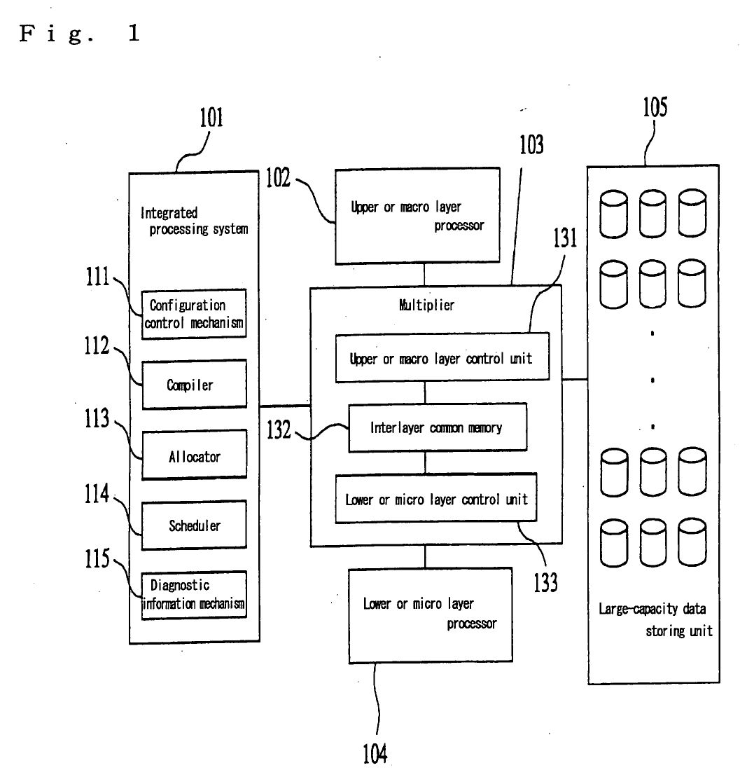

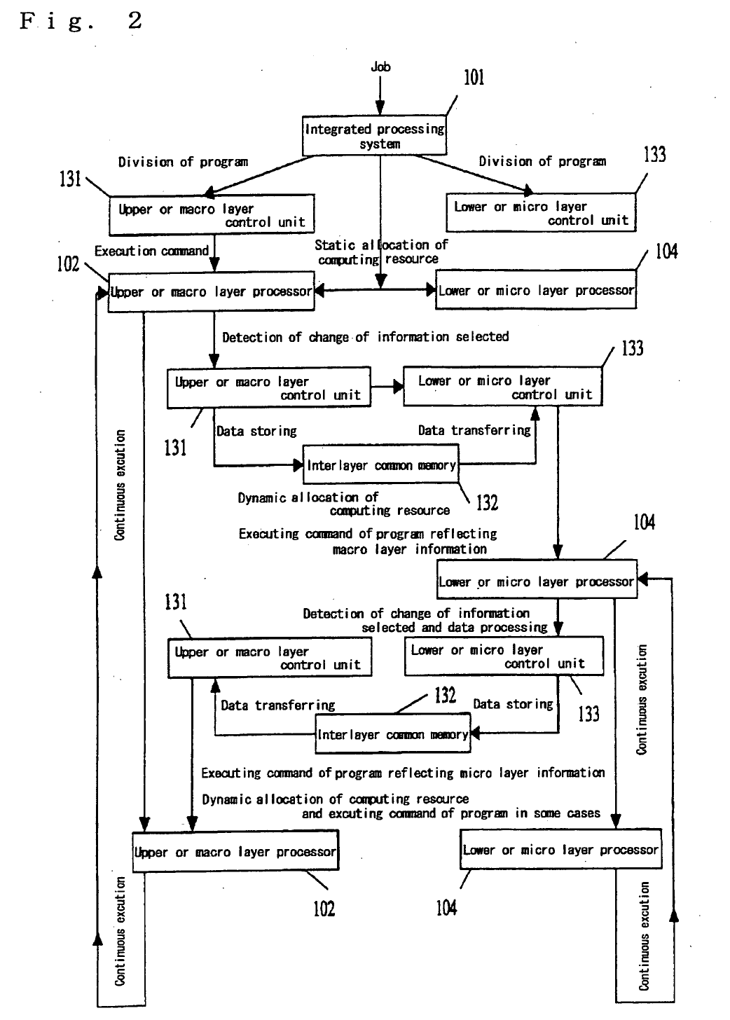

FIG. 1 is a block diagram illustrating the whole construction of a simulator system according to one embodiment of the present invention in a case where an object event of simulation is simulation-processed as to two layers of a macro layer and a micro layer, and FIG. 2 is a block diagram illustrating the flow of the whole process of simulation in the simulator system shown in FIG. 1.

As illustrated in FIG. 1, this simulator system is constructed by an integrated processing system 101, a multiplier 103 connected to the integrated processing system 101 and a large-capacity data storing unit 105 connected to this multiplier 103. To the multiplier 103, are connected an upper layer processor 102 for performing a simulation process as to a macro layer (upper layer) and a lower layer processor 104 for performing a simulation process as to a micro layer (lower layer).

The integrated processing system 101 serves to control the whole of the simulator system and is constructed by a configuration control mechanism 111 for controlling the configuration of the whole simulator system, a compiler 122 for compiling a source code of a job, an allocator 113 for dividing a simulation program corresponding to the job to allocate to the upper layer processor 102 and the lower layer processor 104, a scheduler 114 for controlling the schedule of the whole simulator system, and a diagnostic information mechanism 115 for collecting information for diagnosing the whole simulator system.

The multiplier 103 is a device for connecting the upper layer processor 102 and the lower layer processor 104 to control them and is constructed by an upper layer control unit 131, a lower layer control unit 133 and an interlayer common memory 132 commonly connected to these upper layer control unit 131 and lower layer control unit 133 in this embodiment.

The operation of this simulator system is described with reference to FIG. 2.

The allocator 113 of the integrated processing system 101 statically divides simulation program inputted into a program for the upper layer and a program for the lower layer and allocates load modules as a result of conducting compile by the compiler 112 to the upper layer control unit 131 and the lower layer control unit 133 in the multiplier 103 for conducting connection between the layers and control. In addition, a computing resource necessary for simulation processes in the upper layer processor 102 and lower layer processor 104 is statically allocated.

A case where a simulation process by the upper layer processor is executed precedently will hereinafter be described as an example.

The program allocated to the upper layer control unit 131 is sent to the upper layer processor 102, and an execution command is received from the upper layer control unit 131. When the degree of a change in a kind of information selected by, for example, a user of the simulator system previously has exceeded a preset level (threshold) during the execution of the program, the upper layer processor 102 detects the change and informs the upper layer control unit 131 of data indicating the storing place and kind of the information including this change. The upper layer control unit 131 takes data out of the upper layer processor 102 in accordance with this information to store it in the interlayer common memory 132 and moreover inform the lower layer control unit 133 of the storing place and kind of the information in the interlayer common memory 132.

The lower layer control unit 133 dynamically allocates the computing resource to the lower layer processor 104, transfers the data from the interlayer common memory 132 to the lower layer control unit 133, and commands the lower layer processor 104 to execute a lower layer program transferring the information of the upper layer, whereby the lower layer program is executed. All the while, the upper layer processor 102 continues to execute the original macro layer program. This upper layer processor 102 executes the same process as described above when it detects the fact that the degree of a change in another kind of information has exceeded the preset level, and the lower layer control unit 133 commands the lower layer processor 104 to execute a lower layer program transferring said another information of the macro layer, whereby the lower layer program is executed.

When the degree of a change in a kind of information selected by, for example, the user of the simulator system previously has exceeded a preset level (threshold) during the execution of the simulation according to the micro layer program, the lower layer processor 104 detects the change to perform an information content-reducing process such as a data-summarizing process by, for example, a statistical method for the upper layer processor 102, and informs the lower layer control unit 133 of data indicating the storing place and kind of this information. The lower layer control unit 133 takes data out of the lower layer processor 104 in accordance with this information to store it in the interlayer common memory 132 and moreover inform the upper layer control unit 131 of the storing place and kind of the information in the interlayer common memory 132.

The upper layer control unit 131 transfers the data from the interlayer common memory 132 to the upper layer control unit 131, and commands the upper layer processor 102 to execute a simulation in accordance with a macro layer program transferring the information of the micro layer. As needed, the upper layer control unit 131 dynamically allocates the computing resource to the upper layer processor 102 and commands to execute another program.

A case where a simulation is executed by taking the phenomenon of an aurora-arc formation as an object event of simulation will hereinafter be described specifically.

In a space between the magnetosphere and the ionosphere, banded currents are generated by a macroscopic interaction on a spatially 100,000-km scale and a temporally several thousands-second scale.

However, the mere generation of these currents does not cause the phenomenon of an aurora-arc formation because the kinetic energy of electrons as particles is low.

However, when local currents exceeding a certain threshold are present in the vicinity of the ionosphere, particulate motion of the order of several tens centimeters and 0.1 microsecond by electrons and/or ions creates instability of a micro layer to generate a great electric field accelerating electrons. As a result, the accelerated electrons collide with molecules and atoms of nitrogen and oxygen within the ionosphere to generate arc, resulting in the occurrence of an auroral phenomenon. As a result of this collision, nitrogen and oxygen are ionized, whereby the conditions of the ionosphere are changed, and this change brings a change in the conditions of the interaction of the macro layer of the ionosphere and the magnetosphere. As a result, the current distribution of the macro layer is changed, whereby microscopic conditions come to be further changed. As described above, the macro layer and the micro layer, and the respective interactions closely relate to each other to cause the auroral phenomenon.

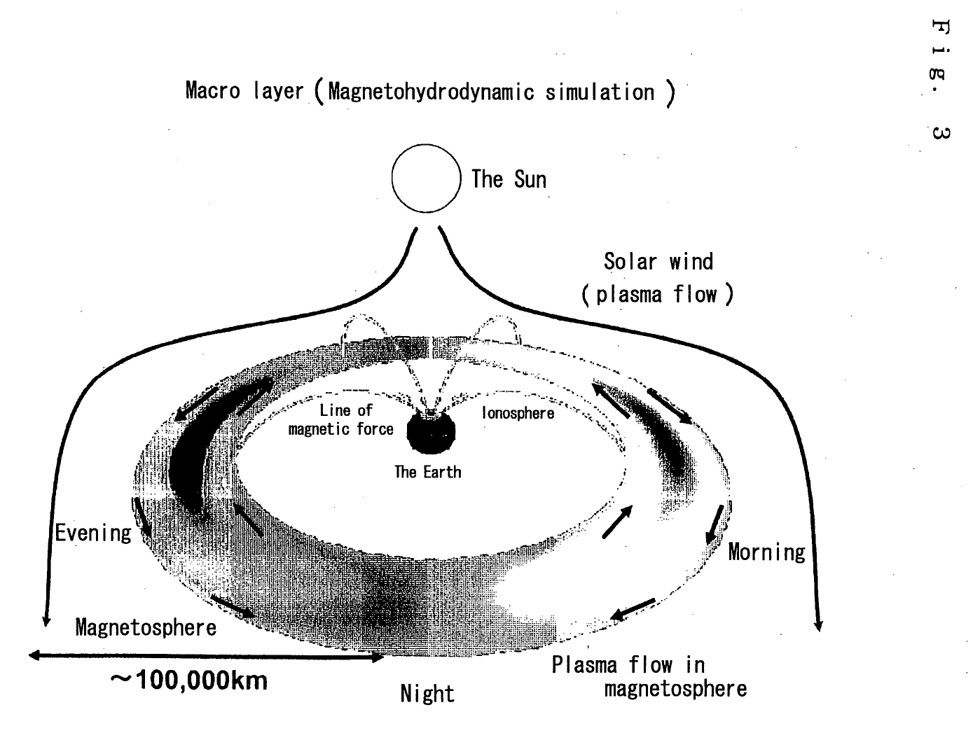

Specifically, as shown in FIG. 3, the plasma flow of a solar wind creates a plasma flow in the magnetosphere as indicated by arrows, and this plasma flow in the magnetosphere and the ionosphere cause a macroscopic interaction along the line of magnetic force of the Earth. With respect to the phenomenon of this portion, it is necessary to perform a macroscopic fluidic simulation called magnetohydrodynamic simulation.

When a region where the value of a current in the vicinity of the ionosphere creates a maximum value of at least a preset proportion of the current in terms of a thermal velocity of electrons, for example, at least 70% is detected, information of the current value in this region is that to be simulated in the micro layer, “the fact that the value of the current in the vicinity of the ionosphere is 70% of the current in terms of the thermal velocity of electrons” is regarded as “the preset level” or “threshold”, and the information of the current value that has reached at least the preset level or threshold is regarded as information to be transferred to a simulation at the micro layer.

In such a case, when a region where the value of the current in the vicinity of the ionosphere creates a maximum value of at least 70% of the current in terms of the thermal velocity of electrons is detected in a simulation at an actual macro layer, the information of this current value is given to a simulation process in the micro layer as change information, and a distribution function of electrons is prepared on the basis of the information of the current value in the simulation process of the micro layer, whereby a particle simulation of electrons and ions in the micro layer is executed as a microscopic simulation process.

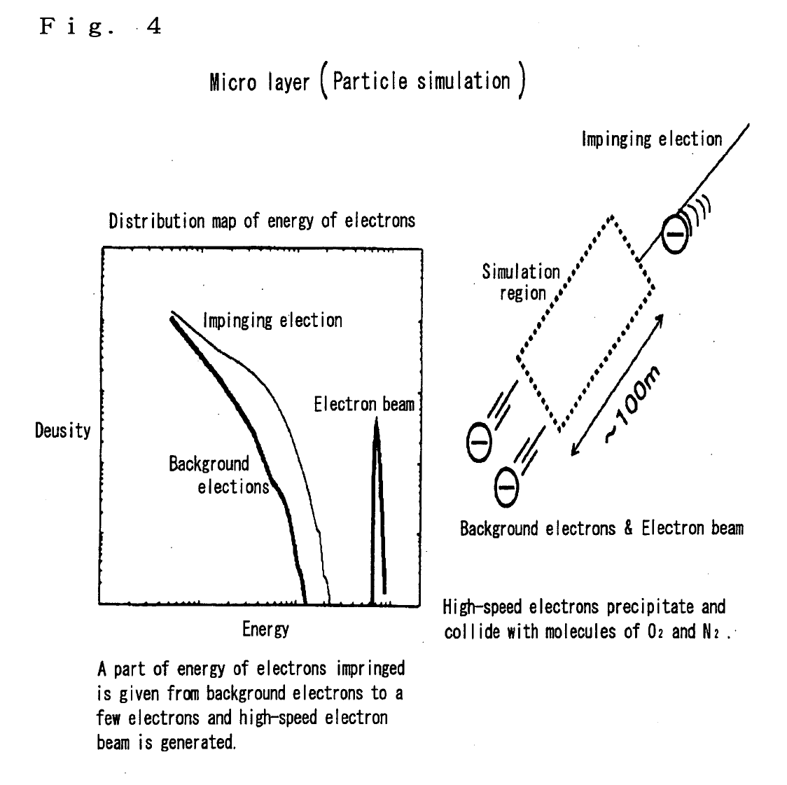

In other words, as illustrated in FIG. 4, a part of energy of electrons impinged on an object region of simulation is given from background electrons to a few electrons, thereby generating a high-speed electron beam, and this high-speed electron beam collides with molecules of oxygen and nitrogen by its precipitation. As a result, an aurora-arc is formed.

Even while such a particle simulation is executed, a fluidic macroscopic simulation is simultaneously executed in parallel in the macro layer because the change in the micro layer is small.

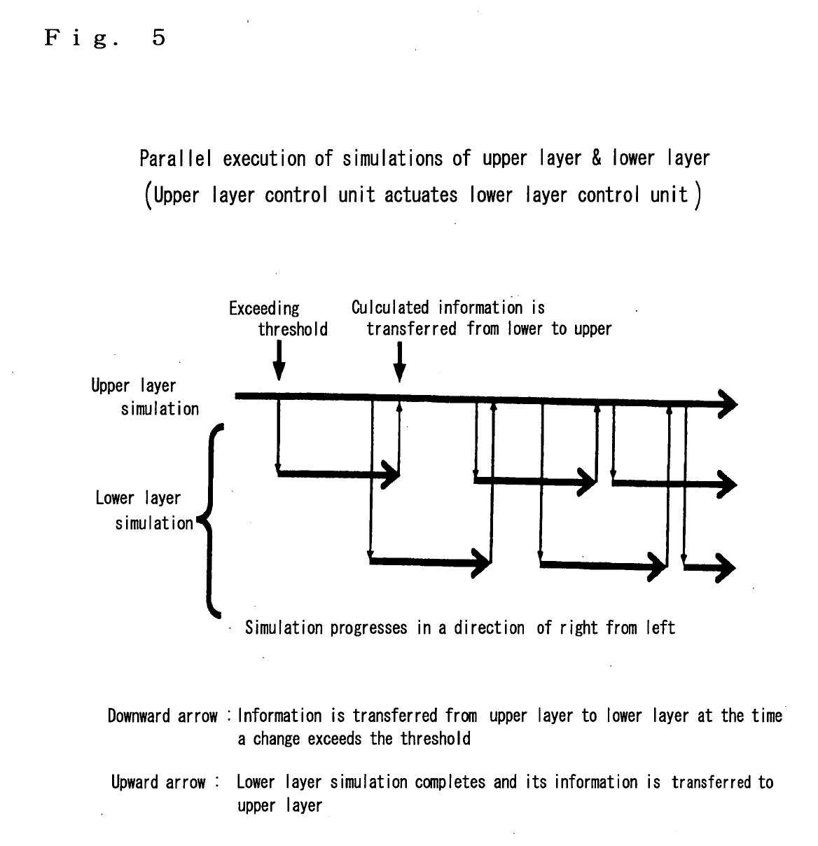

A mode of information exchange between the micro simulation and the macro simulation on a time base at this time is as shown in, for example, FIG. 5.

The mode shown in FIG. 5 is such that the upper layer control unit actuates the lower layer control unit. In this drawing, the simulation progresses in a direction of right from left, downward arrows indicate that at the time a change exceeding the threshold has been detected in the simulation at the upper layer (macro layer), the information including the change is transferred from the macro layer to the micro layer, and upward arrows indicate that the simulation at the lower layer (micro layer) is completed, and the result thereof is transferred to the upper layer and transferred on the simulation at the macro layer. The simulation at the micro layer may be simultaneously executed in parallel as to a plurality of change information from the macro layer.

When a potential difference between the magnetosphere side and the ionosphere side in the micro layer has reached at least 10 times in terms of thermal kinetic energy of electrons, and its state has continued for a period of 100 times as much as an inverse number of plasma oscillation, this numerical value is regarded as “the preset level” or “threshold”, and information of an electron beam current value summarized from the potential difference and the distribution function of electrons on the ionosphere side is given to a simulation process at the macro layer as change information, a simulation process as to the macro layer is executed on the basis of the information.

Further, when change information exceeding the threshold is detected in the simulation at the macro layer, the change information of the macro layer is given to the micro layer, and the simulation process at the micro layer is executed again in parallel with the simulation process at the macro layer.

Such process operations as described above are repeated, whereby phenomena as to two layers, which are different in scale by spatially several billions and temporally several hundreds billions, can be simultaneously solved by the simulation processes.

Accordingly, the magnetohydrodynamic simulation that is the above-described macroscopic simulation process, and the particle simulation that is the microscopic simulation process are executed as the simulation process at the upper layer and the simulation process at the lower layer, respectively, in the simulator system according to the present invention, whereby findings necessary for clarifying a physical mechanism of the aurora-arc formation are obtained as the result of the simulations.

The simulator system according to the present invention has been described specifically above. However, various changes or modifications may be added thereto in the present invention.

For example, the object event of simulation can be simulation-processed as to three layers or more, which are difference in scale from one another, respectively. In that case, it is only necessary to provide layer processors for executing simulation processes as to said three layers or more, respectively, in the simulator system and moreover connect an upper layer processor and a lower layer processor related to each layer group in groups of two layers adjoining each other in all the layers to each other by a multiplier having the same construction as described above. It goes without saying that an integrated processing system including an allocator, which statically divides a simulation program, and controlling the whole simulation, and a data storing unit for storing data obtained by simulations are also provided likewise.

According to such a simulator system, more accurate and minute simulation results can be obtained as to the object event of simulation.

In the above embodiment, the multiplier has an interlayer common memory together with an upper layer control unit connected to the upper layer processor and a lower layer control unit connected to the lower layer processor, and the upper layer control unit and the lower layer control unit are so constructed that informations are exchangeable with each other through the interlayer common memory. However, the present invention is not limited to such a construction. More specifically, it is only necessary that the upper layer control unit and the lower layer control unit are so constructed that informations are exchangeable with each other. The upper layer control unit and the lower layer control unit may be so constructed that informations are exchangeable with each other through a remote direct memory access (RDMA) unit, a bus, a high-speed LAN or the like in place of the interlayer common memory.

For example, a case where the RDMA unit is used is described. When the degree of a change in a selected kind of information has exceeded a preset level in the upper layer processor, an address and a model recognition ID on a memory of the upper layer processor storing the information in the upper layer including said change, together with a signal to the effect that the change has been produced, are communicated to the lower layer processor through the multiplier, and taking this as a cue, the lower layer processor accesses the information in the upper layer including said change on the memory of the upper layer processor using the RDMA unit, whereby a simulation in the lower layer corresponding to the model recognition ID is executed using this information.

On the other hand, when a certain simulation process has be completed in the lower layer processor, an address and a model recognition ID on a memory of the lower layer processor storing the information in the lower layer including the result of the simulation, together with a signal to the effect that the simulation process has been completed, are communicated to the upper layer processor through the multiplier, and taking this as a cue, the upper layer processor accesses the information in the lower layer including the result of the simulation on the memory of the lower layer processor using the RDMA unit, whereby a simulation in the upper layer corresponding to the model recognition ID is executed by using this information.

In the present invention, a simulation process in the layer processor related to each layer may be executed according to a plurality of simulation programs, and not a single simulation program. In particular, in the lower layer processor, the simulation process is preferably executed according to a great number of simulation programs, whereby the result of the simulation taking more detailed changes of conditions into consideration can be obtained.

Incidentally, when a simulation process in one layer is executed according to a plurality of simulation programs, each simulation program does naturally not require a computer.

In the simulator systems according to the present invention, the object event of simulation thereby is not limited, and they can be utilized for simulations as to various phenomena or events. As examples thereof, may be mentioned the following cases.

(1) For example, a change of the air that the circulation of the air, the spatial scale of which is 10,000 km, is regarded as a macro layer, and the motion of cloud or rain, the spatial scale of which is 1 mm, is regarded as a micro layer (in this case, a scale ratio is ten billion times).

(2) For example, an earthquake that a plate motion, the temporal scale of which is several tens years, is regarded as a macro layer, and a fault movement, the temporal scale of which is 1 second, is regarded as a micro layer (in this case, a scale ratio is a billion times).

(3) For example, a meteorological disaster that a meteorological prediction, the temporal scale of which is a week, is regarded as a macro layer, and a landslide, the temporal scale of which is 1 second, is regarded as a micro layer (in this case, a scale ratio is a million times).

(4) For example, a phenomenon in a nano-drug discovery that a drug product, the spatial scale of which is 1 cm, is regarded as a macro layer, and a molecular bonding, the spatial scale of which is 0.1 nm, is regarded as a micro layer (in this case, a scale ratio is a hundred million times).

(5) For example, a nuclear fusion reaction that a core plasma, the spatial scale of which is 10 m, is regarded as a macro layer, and an electron motion, the spatial scale of which is 10 μm, is regarded as a micro layer (in this case, a scale ratio is a ten million times).

(6) For example, a phenomenon in an automobile or the like that the whole product, the spatial scale of which is 1 m, is regarded as a macro layer, and a fuel combustion, the spatial scale of which is 1 nm, is regarded as a micro layer (in this case, a scale ratio is a billion times).

(7) For example, a change of a fuel cell that a gas-liquid flow on a cell, the spatial scale of which is 10 cm, is regarded as a macro layer, and a gas-liquid diffusion, the spatial scale of which is 1 nm, is regarded as a micro layer (in this case, a scale ratio is a hundred million times).

Besides the above, the simulator systems according to the present invention can also be utilized for phenomena or events related to economy and industry.

1-9. (canceled)

10. A simulator system for simulating a temporally and/or spatially changing event, which comprises:
an upper layer processor and a lower layer processor for executing simulation processes as to an upper layer and a lower layer, which are different from each other in scale, respectively;
a multiplier connecting the upper layer processor and the lower layer processor;
an integrated processing system including an allocator, which statically divides a simulation program into a program for the upper layer and a program for the lower layer on the basis of a law system controlling the event about the object event of simulation and allocates them to the upper layer processor and the lower layer processor, respectively, and controlling the whole of the simulation; and
a data storing unit storing data obtained by the simulation,
wherein the upper layer processor and lower layer processor are each constructed by a computer system, wherein the multiplier has an upper layer control unit connected to the upper layer processor and a lower layer control unit connected to the lower layer processor, and the upper layer control unit and the lower layer control unit are so constructed that informations are exchangeable with each other, and
wherein:
(a) when the degree of a change in a selected kind of information has exceeded a preset level in the upper layer processor, the information in the upper layer including said change is transferred from the upper layer processor to the lower layer control unit,
the execution of the simulation process by the upper layer processor is continued, and in parallel therewith, a command to start execution of a simulation process according to a simulation model corresponding to the above change is issued from the lower layer control unit to the lower layer processor to execute the simulation process of the lower layer on the basis of the information transferred to the lower layer control unit in the lower layer processor, and/or
(b) when the degree of a change in a selected kind of information has exceeded a preset level in the lower layer processor, the information in the lower layer including said change is transferred from the lower layer processor to the upper layer control unit,
the execution of the simulation process by the lower layer processor is continued, and in parallel therewith, a command to start execution of a simulation process according to a simulation model corresponding to the above change is issued from the upper layer control unit to the upper layer processor to execute the simulation process of the upper layer on the basis of the information transferred to the upper layer control unit in the upper layer processor.

11. The simulator system according to claim 10, wherein the upper layer control unit and the lower layer control unit are so constructed that informations are exchangeable with each other through a communicating system selected from an interlayer common memory, a remote direct memory access unit, a bus and a high-speed LAN.

12. The simulator system according to claim 10, wherein simulation processes by different simulation models are executed at the same time in the upper layer processor and lower layer processor, respectively.

13. The simulator system according to claim 10, wherein the transfer of the midway information in the course of the execution of the simulation process in the upper layer processor or lower layer processor is executed only when the degree of a change in a selected kind of information has exceeded the preset level in the upper layer processor or lower layer processor.

14. The simulator system according to claim 10, wherein, the information transferred to the upper layer processor and the information transferred to the lower layer processor are that subjected to an information content-reducing process corresponding to a simulation program executed in the upper layer processor or lower layer processor.

15. The simulator system according to claim 10, wherein the scale of the layer of the simulation process executed in the upper layer processor is at least 100,000 times as much as the scale of the layer of the simulation process executed in the lower layer processor.

16. A simulator system for simulating a temporally and/or spatially changing event, which comprises:
layer processors for executing simulation processes as to at least three layers, which are different from one another in scale, respectively;
a multiplier connecting an upper layer processor and a lower layer processor related to two layers adjoining each other in said at least three layers to each other;
an integrated processing system including an allocator, which statically divides a simulation program into a program for the upper layer and a program for the lower layer on the basis of a law system controlling the event about the object event of simulation and allocates them to the upper layer processor and the lower layer processor, respectively, and controlling the whole of the simulation; and
a data storing unit storing data obtained by the simulation,
wherein the layer processors are each constructed by a computer system,
wherein the multiplier has an upper layer control unit connected to the upper layer processor and a lower layer control unit connected to the lower layer processor, and the upper layer control unit and the lower layer control unit are so constructed that informations are exchangeable with each other, and
wherein:
(a) when the degree of a change in a selected kind of information has exceeded a preset level in the upper layer processor, the information in the upper layer including said change is transferred from the upper layer processor to the lower layer control unit,
the execution of the simulation process by the upper layer processor is continued, and in parallel therewith, a command to start execution of a simulation process according to a simulation model corresponding to the above change is issued from the lower layer control unit to the lower layer processor to execute the simulation process of the lower layer on the basis of the information transferred to the lower layer control unit in the lower layer processor, and/or
(b) when the degree of a change in a selected kind of information has exceeded a preset level in the lower layer processor, the information in the lower layer including said change is transferred from the lower layer processor to the upper layer control unit,
the execution of the simulation process by the lower layer processor is continued, and in parallel therewith, a command to start execution of a simulation process according to a simulation model corresponding to the above change is issued from the upper layer control unit to the upper layer processor to execute the simulation process of the upper layer on the basis of the information transferred to the upper layer control unit in the upper layer processor.

17. The simulator system according to claim 16, wherein the upper layer control unit and the lower layer control unit are so constructed that informations are exchangeable with each other through a communicating system selected from an interlayer common memory, a remote direct memory access unit, a bus and a high-speed LAN.

18. The simulator system according to claim 16, wherein simulation processes by different simulation models are executed at the same time in the upper layer processor and lower layer processor, respectively.

19. The simulator system according to claim 16, wherein the transfer of the midway information in the course of the execution of the simulation process in the upper layer processor or lower layer processor is executed only when the degree of a change in a selected kind of information has exceeded the preset level in the upper layer processor or lower layer processor.

20. The simulator system according to claim 16, wherein, the information transferred to the upper layer processor and the information transferred to the lower layer processor are that subjected to an information content-reducing process corresponding to a simulation program executed in the upper layer processor or lower layer processor.

21. The simulator system according to claim 16, wherein the scale of the layer of the simulation process executed in the upper layer processor is at least 100,000 times as much as the scale of the layer of the simulation process executed in the lower layer processor.
